(19) United States
(12) Patent Application Publication
(10) Pub. No.: US 2006/0269091 A1
(43) Pub. Date: Nov. 30, 2006

(54) Device-mountable speaker set

(76) Inventor: Eagle Fan, Chu-Pei City (TW)

Correspondence Address: LIN & ASSOCIATES INTELLECTUAL PROPERTY, P.O. BOX 2339, SARATOGA, CA, 95070-0339, US

(21) Appl. No.: 11/139,884

(22) Filed: May 27, 2005

(51) Int. Cl. H04R 1/02

(52) U.S. Cl. 381/386

(57) ABSTRACT

A device-mountable speaker set includes a base forming a top platform on which two speakers are movably mounted. The speakers are movable away from/toward each other in transverse direction to increase/decrease the distance therebetween. The increased distance between the speakers enhances sound surrounding effect. The distance between the speakers allows for accommodation of an electronic device, such as a sound generation device, for example a MP3 player and a CD player, on the top platform. The device can be retained between the speakers whereby the speaker set is mounted to the device to enhance the operability of the device.

### BACKGROUND OF THE INVENTION

1. Field of the Invention

The present invention relates generally to loud speakers, and in particular to a speaker set that can be removably mounted to a sound generation device or musical playing device to enhance operability of the device.

2. The Prior Arts

The advance of the electronics brings on miniaturization and variety of electrical appliances. For example, a variety of electronic devices, including multi-media device and musical playing devices, are now available in the market. Examples include MP3 player, MP4 player, CD/DVD player, palm-held game machine, personal digital assistant, and mobile phones. Most of these devices are capable of playing digital musical in various formats. Thus, these are devices are provided with a built-in speaker. However, the built-in speaker is generally not capable to provide sounds of excellent quality and is lack of sound surrounding effect. External speaker sets are often employed to enhance sound quality for these electronic devices. However, the external speaker set is often of bulky size, which is against the miniaturization trend.

Thus, the present invention is aimed to provide a speaker set for electronic sound generation device, which overcomes bulkiness of conventional external speaker set.

### SUMMARY OF THE INVENTION

An objective of the present invention is to provide a speaker set that is mountable to a sound-generation device or audio/video device, such as an MP4 player, to combine the sound-generation device and the speaker set together for enhanced operability, wherein the speaker set comprises a base and two speakers that are transversely movable to change the distance between the speaker, in which the sound-generation device is positionable and releasably secured between the speakers. Listening music or watching movie in a dynamic environment, such as taking a bus, can be easily done with such a combination of the speaker set and the device.

Another objective of the present invention is to provide a speaker set of enhanced sound-surrounding effect by selectively increasing the distance between two speakers and of reduced amount of stowage space by decreasing the distance between the speakers.

A further objective of the present invention is to provide a speaker set of wide applications in different locations and sites, which overcomes the limitation of the conventional speakers that must be positioned on a substantially horizontal surface, such as a desktop, by providing the speaker set with the feature of being mountable to a device whereby the device and the speaker set are combined as a single stand-along device. Further, with the aid of additional mounting device, such as a suction cup, the speaker set and the device that is combined with the speaker set are securely positionable on any surfaces or fixtures, such as being attached to a glass surface, whereby applications of the speaker set is substantially enhanced.

In accordance with the present invention, to realize the above objectives, a speaker set comprises a base forming a platform and two speakers movably mounted to opposite sides of the platform. The speakers are movable away from each other to increase the distance therebetween, which enhances the sound surrounding effect of the speakers. The distance between the speakers also serves as a space to accommodate a sound-generation device or an audio/video playing device, which can be secured in positioned by being clamped by the speakers on opposite edges. The speakers can be selectively moved toward each other to reduce the amount of space occupied thereby, which enhance storage of the speaker set.

The present invention will become more obvious from the following description when taken in connection with the accompanying drawings, which show, for purposes of illustration only, a preferred embodiment in accordance with the present invention. In the drawings:

### BRIEF DESCRIPTION OF THE DRAWINGS

FIG. 1 is a top plan view of a speaker set constructed in accordance with the present invention in a closed condition;

FIG. 2 is a perspective view of the speaker set of the present invention in an open condition;

FIG. 3 is an exploded view of the speaker set of the present invention;

FIG. 4 is a cross-sectional view taken along line A-A of FIG. 1, but only a base and a stand of the speaker set are shown in section;

FIG. 5 is a cross-sectional view taken along line B-B of FIG. 1, but only the base and a retainer member are shown in section;

FIG. 6 is a cross-sectional view showing pivotal connection between the base and the stand of the speaker set of the present invention; and

FIG. 7 is a perspective view showing an application of the speaker set of the present invention.

### DETAILED DESCRIPTION OF THE PREFERRED EMBODIMENT

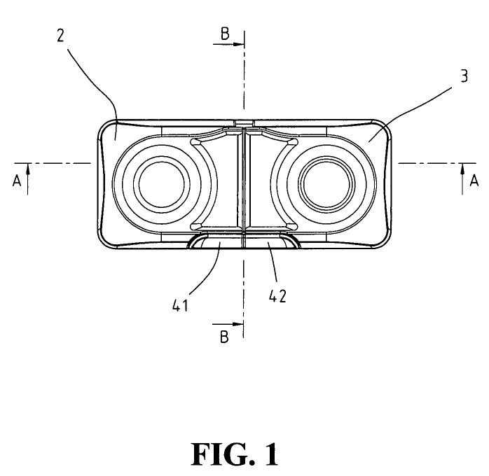

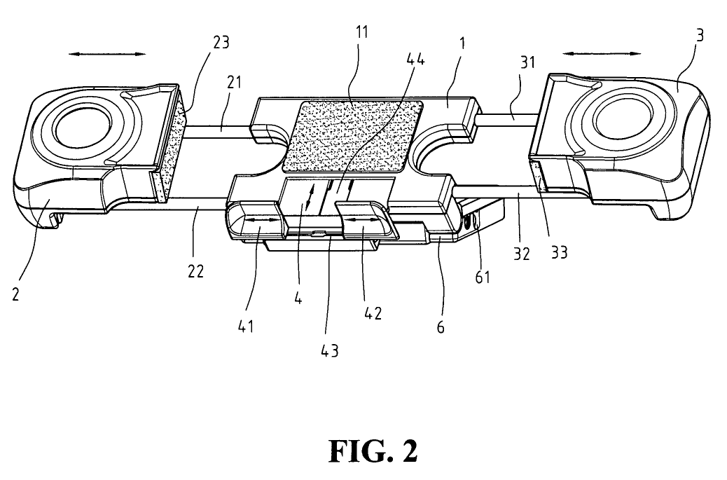

With reference to the drawings, and in particular to FIGS. 1 and 2, which shows a device-mountable speaker set constructed in accordance with the present invention in a closed and an open conditions, respectively, the speaker set of the present invention comprises a base 1 and two speakers 2, 3 movably mounted on the base 1. The base 1 forms a casing inside which electronic parts and circuits for driving the speakers 2, 3 are housed and retained. Such an arrangement is helpful in reducing overall size of the speaker set. The base 1 is constructed to be positionable on a fixed surface, such as a desk (not shown), or alternatively and as shown in the drawings, the base 1 comprises an additional stand 6, which is simply positionable on the fixed surface, or which is releasably attachable to the fixed surface. In the case where the base 1 is provided with the additional stand 6, the electronic parts and circuits for driving the speakers 2, 3 can be encased in the stand 6, rather than the base 1. This makes the base 1 compact.

The base 1 is pivoted to the stand 6 whereby the base 1 can be rotatable with respect to the stand 6 and thus the fixed surface on which the stand 6 is positioned. The orientation of the base 1 and thus the speakers 2, 3 that are movably mounted to the base 1 can be changed by rotatably moving the base 1 with respect to the stand 6. Thus, as shown in FIG. 2, with the stand 6 positioned on a horizontal surface (not shown), the base 1 and the speakers 2, 3 can be made inclined with respect to the horizon.

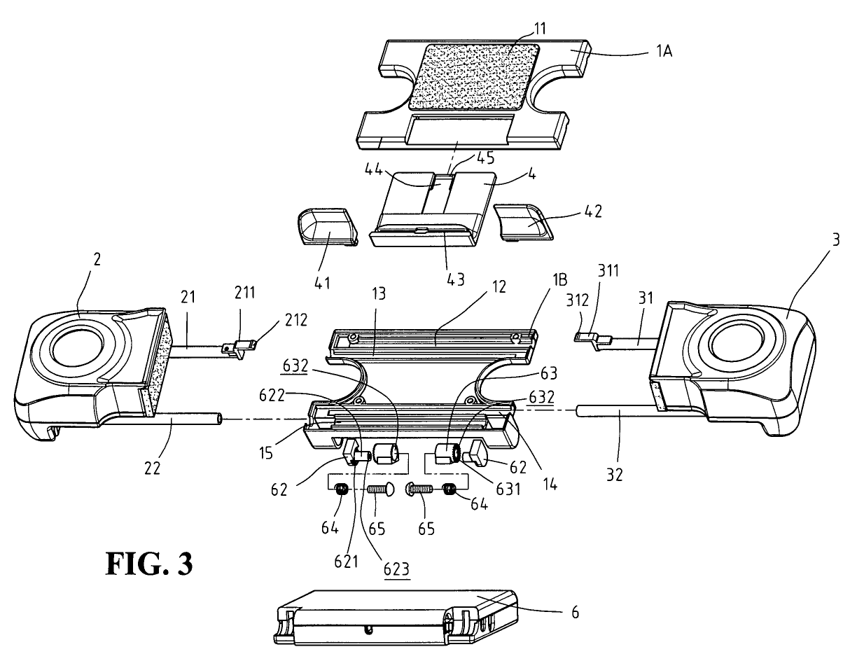

Also referring to FIG. 3, each speaker 2, 3 comprises a casing (not labeled) from which a plurality of guide rods 21, 22 or 31, 32 extend in a direction toward the base 1. The guide rods 21, 22, 31, 32 are slidably received in the base 1 whereby the speaker 2, 3 is movable away from/toward the base 1 by the sliding movement of the guide rods 21, 22, 31, 32 with respect to the base 1. By moving the speakers 2, 3 away from the base 1, the distance between the speakers 2, 3 is increased, which in turn enhances the surrounding effect of the speaker set and thus improve sound quality.

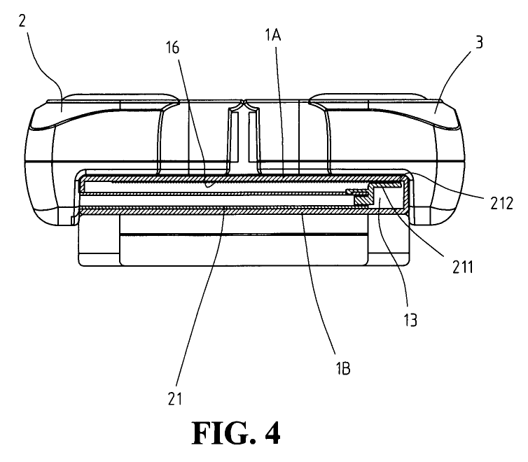

In the embodiment illustrated, the casing of the speaker 2, 3 comprises a lower projection depending from a remote edge thereof in a right angle, making the casing a lying-down L-shape, whereby when the speakers 2, 3 are in the closed position as shown in FIG. 1, the casings of the speakers 2, 3 are positionable on and substantially completely shielding a platform 11 formed by a top face of the base 1. The lower projections of the casings are in abutment engagement with opposite side edges of the base 1 as shown in FIG. 4.

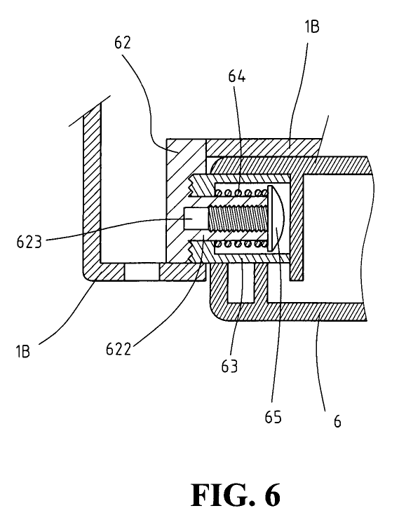

Each speaker 2, 3 has an inward-facing clamping surface 23, 33, which are engageable with each other when the speakers 2, 3 are in the closed condition. The clamping surfaces 23, 33 and the top platform 11 together delimit a receiving space (not labeled) in which an electronic device (see FIG. 6), in particular a music playing device, is receivable. The device is positionable on the top platform 11 of the base 1 and is retained in position by being clamped by the clamping surfaces 23, 33 by moving the speakers 2, 3 toward the device to form engagement between the clamping surface 23, 33 with opposite edges of the device. The adjustable distance between the speakers 2, 3 is not only helpful in retaining the device in position, but is also helpful in accommodating devices of different sizes.

Preferably, the clamping surface 23, 33 is provided with a coating of flexible and high-friction materials, such as foamed rubber.

The base 1 is constituted by upper and lower casing members 1A, 1B. Transversely extending slots 12, 13, 14, 15 are defined in the lower casing member 1B for slidably receiving the guide rods 21, 22, 31, 32 of the speakers 2, 3. In the embodiment illustrated, the guide rods 21, 22 of the left-hand side speaker 2 are received in the slots 13, 15, while the guide rods 31, 32 of the right-hand side speaker 3 are received in the slots 12, 14. This arrangement allows the speakers 2, 3 to be movable transversely with respect to the base 1.

Also referring to FIG. 4, two serrated sections 16, which extends in the transverse direction, are defined in the upper casing member 1A, corresponding in position to and substantially parallel to and opposing the slots 12, 13 of the lower casing member 1B. Each serrated section 16 is comprised of a plurality of tooth-like projections spaced in the transverse direction. The guide rods 31, 21 that are slidably received in the slots 12, 13 are each provided with a resilient tab 311, 211 that is resiliently biased toward and thus making a tooth 312, 212 thereof engageable with the projections of the serrated section 16. This serves to selectively position the speaker 2, 3 with respect to the base 1.

In the embodiment illustrated, the base 1 is substantially rectangular, having opposite lateral side edges to which the speakers 2, 3 are movably mounted and lower and upper edges extending between the lateral side edges. To more stably support and retain the device in the receiving space defined by the clamping surfaces 23, 33 of the speakers 2, 3 and the top platform 11 of the base 1, a retainer 4 is movably mounted to the lower edge of the base 1. The retainer 4 has a remote edge on which two movable blocks 41, 42 are movably mounted. The blocks 41, 42 project upward beyond the top platform 11 of the base 1 to serve as a lower support for the device positioned on the top platform 11.

The retainer member 4 defines a slot 43 along the remote edge thereof and substantially parallel to the lower edge of the base 1. The blocks 41, 42 have lower projections (not labeled) movably received in the slot 43 for guiding sliding movement of the blocks 41, 42 along the slot 43. Thus, the distance between opposite ends of the blocks 41, 42 is selectively increased to cooperate with the outward movement of the speakers 2, 3 for retaining a large-size device on the top platform 11 of the base 1.

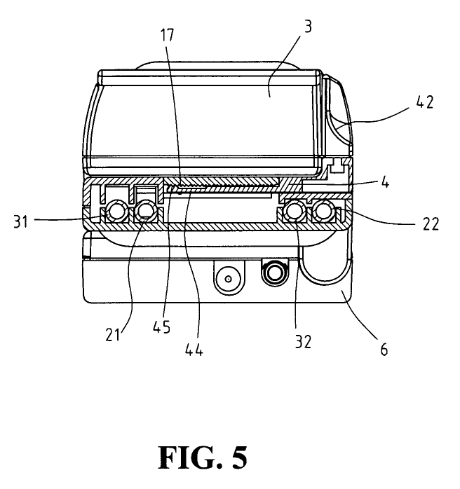

Also referring to FIG. 5, the retainer member 4 can be of any desired configuration, and is comprised of a board-like flat body in the embodiment illustrated. The board of the retainer member 4 is received in a slot (not labeled) defined in the base 1 whereby the board is movable between a stowed position where the board is completely received inside the base 1 and an extended position where the board is withdrawn out of the slot of the base 1. The board of the retainer member 4 forms a resilient tab 44 having a free end on which a tooth 45 is formed. The tooth 45 is biased by the resiliency of the tab 44 to engage with a serrated section 17 formed inside the base 1 to selectively position the retainer member 4 with respect to the base 1.

As mentioned previously, the stand 6 not only supports the base 1 in a selectively inclined manner, but may also serve as a casing for housing electronic parts and circuits for driving the speakers. If desired, the speaker set of the present invention can be powered by a built-in battery based power supply. In this case, the stand 6 also serves as a battery compartment for accommodating the battery. The speaker set can also be powered by an external power source, such as an electric main. A power jack 61 is formed in the stand 6 for selective connection with a power cord that supplies power from the external power source to the circuit inside the stand 6. If desired, power transformer and associated circuit can also be housed in the stand 6.

Also referring to FIG. 6, the base 1 is pivoted to the stand 6. The pivotal connection between the base 1 and the stand 6 comprises first and second blocks 62, 63, which are respectively fixed to the base 1 and the stand 6. The blocks 62, 63 are of non-circular cross-sections, whereby the blocks 62, 63 are not rotatable with respect to the base 1 and the stand 6 but at least one of the blocks 62, 63 (such as the first block 62) is axially movable whereby the blocks 62, 63 are axially movable toward each other. The blocks 2, 3 have opposing ends in which mating serrations 621, 631 are formed. The first block 62 has a central post 622 that axially and movably extends through a bore 632 defined in the second block 63. The post 622 forms an internally threaded hole 623 that engages a bolt 65 to secure the blocks 62, 63 together. A biasing element 64, such as a helical spring, is provided between the blocks 62, 63 to bias the blocks 62, 63 toward each other in an axial direction, thereby urging the serrations 621, 631 to engage each other. The helical spring 64 encompasses the post 622 and is fixed at opposite ends by the second block 63 and a head portion of the bolt 65 that engages the first block 62.

When the base 1 is rotated with respect to the stand 6, the serrations 621, 631 that are formed of inclined projections induce a camming action therebetween, which camming action moves the blocks 62, 63 away from each other against the biasing force of the spring 64. Once the serrations 621, 631 move to the next projections, the camming action disappears and the biasing force of the spring 64 forces the serrations 621, 631 back into engagement with each other thereby positioning the base 1 at a new angle with respect to the stand 6.

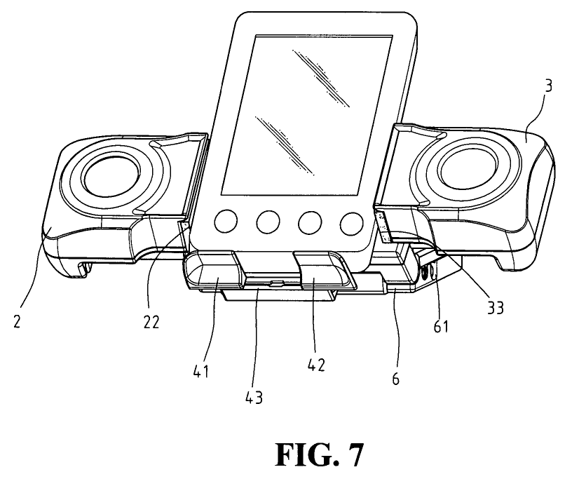

FIG. 7 shows an illustrative application of the speaker set in accordance with the present invention. The speakers 2, 3 are moved away from each other to increase the distance therebetween. The support blocks 41, 42 of the retainer member 4 are also separated from each other in correspondence with the movement of the speakers 2, 3. An electronic device, or sound generation device (not labeled) is positioned on the top platform 11 of the base 1 that is exposed after the speakers 2, 3 are moved away from each other. The lower edge of the electronic device is supported by the support blocks 41, 42. The device is retained in position by the clamping surfaces 23, 33 of the speakers 2, 3.

As mentioned previously, the base 1 itself can be positioned on a fixed surface, in either a fixed manner or a releasable manner, by means of for example a suction cup (not shown). Or alternatively, in case the stand 6 is provided, the stand 6 can be similarly positioned on the fixed surface by the suction cup.

Although the present invention has been described with reference to the preferred embodiment thereof, it is apparent to those skilled in the art that a variety of modifications and changes may be made, for example replacing the bowl with a fork, without departing from the scope of the present invention which is intended to be defined by the appended claims.

What is claimed is:

1. A speaker set comprising:
a base having a top platform;
two speakers each movably mounted to the base by a plurality of guide rods extending from the speaker and transversely and slidably received in the base whereby inward-facing surfaces of the speakers that oppose each other are movable with respect to each other to define a space therebetween for accommodating a device.

2. The speaker set as claimed in claim 1, wherein the base defines a plurality of slots in which the guide rods are slidably received.

3. The speaker set as claimed in claim 2, wherein at least two serrated sections are formed in the base and corresponding in position to two of the slots, each speaker having a resilient tab formed one of the guide rods thereof to support and bias a tooth to engage the associated serrated section.

4. The speaker set as claimed in claim 1 further comprising a retainer member that movably supports two support blocks that are positioned along a lower edge of the base and that project beyond the top platform.

5. The speaker set as claimed in claim 4, wherein the retainer member forms a slot along which the support blocks move.

6. The speaker set as claimed in claim 4, wherein the retainer member is movable with respect to the base, the retainer member comprising a resilient tab that supports and biases a tooth to engage a serrated section formed in the base to selectively position the retainer member with respect to the base.

7. The speaker set as claimed in claim 1 further comprising a stand to which the base is pivoted whereby the base is positionable in an upward inclined condtion.
